(19) United States
(12) Patent Application Publication
(10) Pub. No.: US 2009/0145940 A1
(43) Pub. Date: Jun. 11, 2009

(54) UTILITY RACK FOR A VEHICLE

(76) Inventor: Ben W. Bukowiec, Sobieski, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/953,589

(22) Filed: Dec. 10, 2007

(51) Int. Cl. B60R 9/042

(52) U.S. Cl. 224/310

(57) ABSTRACT

A utility rack for mounting onto the top surface of a vehicle. The utility rack includes at one side assembly for receiving an object. The utility rack side assembly includes a front end and back end that can be raised and lowered in unison through the use of extendible, elongated pivoting members. A drive assembly is connected to the utility side rack assemblies. A control unit functionally connects the drive assembly for raising and lowering the at least one side assembly. The vehicle top surface mounting assembly support the utility rack side assembly and the drive assembly on the top surface of the vehicle. The elongated pivoting members include extendible bracket units that slideably extend and retract from a distal end of the elongated pivoting member and activated by the drive assembly. The front and back ends of the utility rack side assembly can be moved substantially in unison from a first position generally parallel with the top surface of the vehicle to a second, extended position generally perpendicular to the top surface of a vehicle to move an object located in a storage position at the top surface of the vehicle to an accessible position to a person standing at ground level.

### BACKGROUND OF THE INVENTION

The present disclosure relates to a an apparatus for loading and unloading objects onto the top surface of a vehicle.

Large objects and equipment such as extension ladders, pipes, conduits, sheet metal, and tool boxes are typically transported on fixed racks on the roofs of service vehicles, commonly trucks or vans. Loading and unloading of such heavy or awkward equipment from fixed racks requires heavy lifting or balancing of large objects that may result in injury to the service person or damage to the vehicle.

While improvements to fixed racks are known in the art, such improvements only can handle limited equipment such as full length extension ladders, and only provide motorized lifting on one end of the ladder. An example of this prior art is U.S. Pat. No. 5,850,891 incorporated herein by reference. While prior art rack systems help in assisting the service person, significant strain on the service person is still present because the service person must remove a fixed portion of the ladder from the vehicle. Additionally, the limitations of prior art racks are significant in that that they are not capable of handling many different large pieces of equipment and are generally limited to use on ladders only.

To overcome these disadvantages, the present disclosure has an apparatus for raising and lowering large pieces of equipment on top of service vehicles, and particularly on top of tall service vehicles such as a Dodge® Sprinter van. The present invention lifts both sides of the large pieces of equipment smoothly and easily through front and back extensions to and from the top surface of the vehicle. Moreover, the disclosure of the present application allows securing of the large equipment at ground level, significantly reducing the strain on the individual service provider. The apparatus of the present disclosure also provides interchangeability for accessories, such as a tool box, and allows for the utility rack to be used for an unlimited universe of large pieces of equipment to be transported to the top of the service vehicle while being secured at ground level.

Accordingly, the utility rack of the present application includes at least one utility rack side assembly for receiving an object. The utility rack side assembly includes a front end and a back end. Both the front end and the back end each include an extendible, elongated pivoting member. A drive assembly is connected to the utility side rack assembly. The drive assembly includes at least one motor and at least one drive shaft connected to a motor. The drive shaft connects the front and back ends of the utility rack side assembly in a functional manner. A control unit is connected to the drive assembly for activating the drive assembly. In one embodiment, the control unit is located inside of the vehicle. The utility rack also can include front and back vehicle top surface mounting assemblies for supporting the utility rack side assembly at the front end and back ends on the top surface of a vehicle, and also for supporting the drive assembly on the top surface of a vehicle.

Each elongated pivoting member includes an extendible bracket unit that slideably extends from and retracts into a distal end of the elongated pivoting member. The lower end of the extendible bracket unit has a surface for receiving an object, for example, a ladder, tool box, or the like. In one embodiment, the surface for receiving an object is a surface for receiving a ladder. In another embodiment, the surface is adapted for receiving an elongated tool box, the tool box extending from the front end to the back end of the side assembly. The tool box may further include an outer surface for receiving an additional object, such as a ladder.

The drive assembly operates to move a front end and back end of a utility rack side assembly substantially in unison from a first position generally parallel with the top surface of the vehicle to a second, extended position generally perpendicular to the top surface of the vehicle and downwardly along the side of the vehicle. In this manner, an object may be loaded by a person standing at ground level and may be moved to a storage position located at the top surface of the vehicle.

In another embodiment, the utility rack includes first and second utility side rack assemblies, each side rack assembly having a front end and a back end. The front end and back ends each comprise an extendible, elongated pivoting member, and each elongated pivoting member includes an extendible bracket unit that slideably extends from and retracts into a distal end of the elongated pivoting member when activated. The lower end of the extendible bracket unit has a surface for receiving an object. That object may be a ladder, a tool box, or the like.

A drive assembly is connected to the utility side rack assemblies. The drive assembly includes a motor and a first and second drive shaft, the first drive shaft connecting to the front and back ends of the first utility side rack assembly, and the second drive shaft connecting to the front and back ends of the second drive shaft assembly. Each drive shaft has a front and back cable spooling mechanism. Each cable spooling mechanism has a cable coupled thereto, with each cable further coupled to an extendible, elongated pivoting member to extend or retract the extendible bracket unit. Thus, when the drive shaft is activated, the front and back ends of the utility side rack assembly can move substantially in unison. The drive shaft assembly operates to selectively move the first or second utility side rack assemblies from a first position generally parallel with the top surface of the vehicle to a second, extended position generally perpendicular to the top surface of the vehicle and downwardly along the side of the vehicle such that a person standing at ground level may easily access the extendible bracket units of both the front and back ends of the utility rack side assembly.

In one embodiment, the drive assembly also includes at least one biasing member to bias the elongated pivoting member to the second, extended position. The biasing member may be at least one pneumatic strut.

In another embodiment, the motor is a reversible motor and the motor drives the extension or retraction of cable from the cable spooling mechanisms, such that when the cable is extended, the elongated pivoting members move to the second, extended position, and when the cable is retracted, the elongated pivoting members move to the first position.

### BRIEF DESCRIPTION OF THE SEVERAL VIEWS OF THE DRAWINGS

FIG. 1 is a perspective view of the utility rack system assembly in a storage position on the top of a vehicle;

FIG. 2 is a perspective view of the utility rack assembly system in an extended position providing access to a person standing at ground level;

FIG. 3 is an exploded perspective view of a front or back portion of a first and second utility side rack assembly;

FIG. 4 is an exploded perspective view of an extendible, elongated pivoting member;

FIG. 5 is a top view of the utility rack system assembly;

FIG. 6 is a front end view of the utility rack system assembly demonstrating exemplary pivot angles.

### DETAILED DESCRIPTION OF THE INVENTION

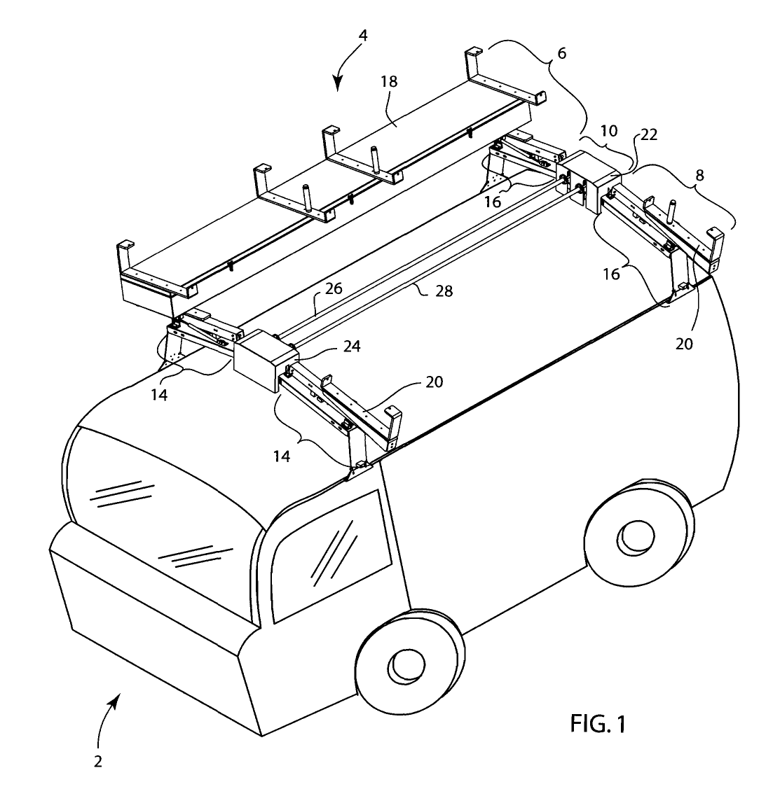

Referring first to FIG. 1, a vehicle 2 has a utility rack system assembly 4 mounted on the top surface or roof of the vehicle 2. The vehicle 2 is commonly a van or a truck. In one embodiment, the vehicle 2 is a Dodge® Sprinter. However, the vehicle 2 may be any vehicle that has a top surface or roof adaptable to receive a utility rack system assembly 4. The utility rack system assembly 4 is adaptable to be mounted on the top surface of the vehicle 2. An exemplary utility rack system assembly 4 comprises a first utility rack side assembly 6, a second utility rack assembly 8, a drive assembly 10, a control unit (not shown), a first vehicle top surface mounting assembly 14, and a second vehicle top surface mounting assembly 16. The utility rack assembly 4 may be suitably modified to include only one utility rack side assembly. In that embodiment, the drive assembly 10 and first and second vehicle top surface mounting assemblies 14 and 16 will be modified accordingly.

The first and second utility rack side assemblies 6, 8 are adaptable to receiving an elongated, large piece of equipment. In the exemplary embodiment shown in FIG. 1, a tool box 18 is affixed to the first utility rack side assembly 6 and a ladder hold down assembly 20 is affixed to the second utility rack assembly 8. However, it is contemplated that the side assembly 6 and 8 may be modified to engage any object that is desired to be carried thereupon, including but not limited to, pipes, ladders, lumber, building materials, tool boxes and the like. The ability of the utility rack system assembly 4 to hold an object is not a limitation on the present invention and the surfaces can be customized to hold virtually any object a customer desires.

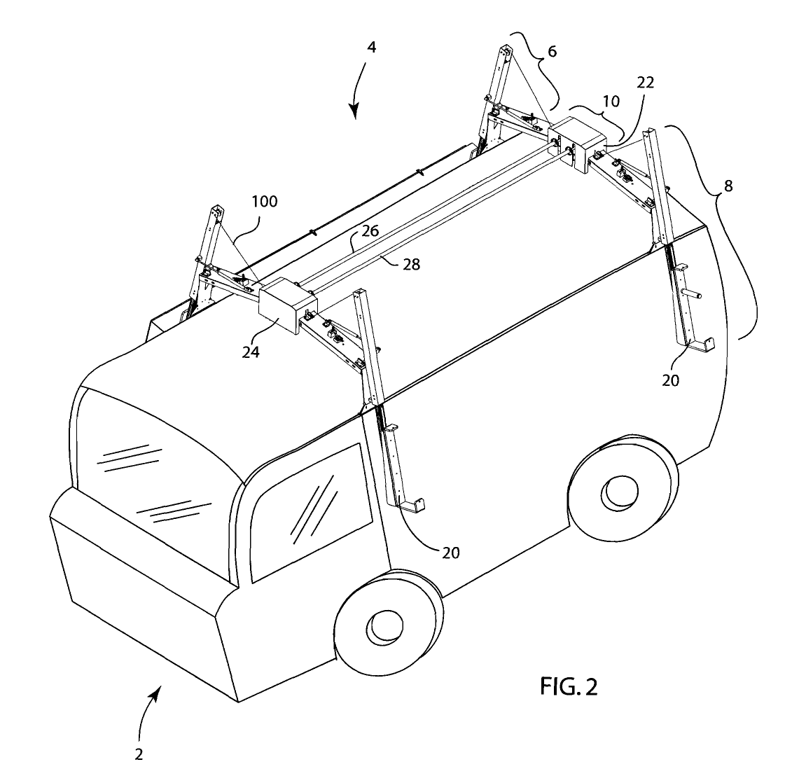

First and second utility rack side assemblies 6, 8 are connected to a drive assembly 10 to raise and lower the respective side rack assemblies as shown in a comparison of FIGS. 1 and 2. The length of the side assembly 6, 8 may be adjusted depending on the height of the vehicle.

The drive assembly 10 is operatively connected to the respective utility side rack assemblies 6, 8. The drive assembly 10 comprises at least one motor 30 operable to rotate first and second drive units 22, 24 connected by first and second drive shafts 26, 28. Drive shafts 26, 28 are functionally connected to at least one motor 30 that is operable to rotate drive shafts 26, 28 to effect movement of side assembly 6, 8 as will be further explained herein. In one embodiment, the motor 30 is located at the front drive unit 24, but may be located elsewhere. In another embodiment, a motor 30 is located at front drive unit 24, and a second motor 30′ is located at the back drive unit 22. In yet another embodiment, two motors are located at front unit 24, one motor provided for each respective drive shaft 26, 28.

Actuation of the drive assembly 10 to raise and lower side assembly 6, 8 is done through the control unit (not shown). In one embodiment, the control unit is located inside the vehicle 2. However, the control unit may also be located at other locations, such as on the outside of the vehicle. The control unit has controls that allow an operator to raise and lower the utility rack system. (NOTE TO INVENTOR: PLEASE ELABORATE ON CONTROL UNIT'S BUTTONS, ETC.)

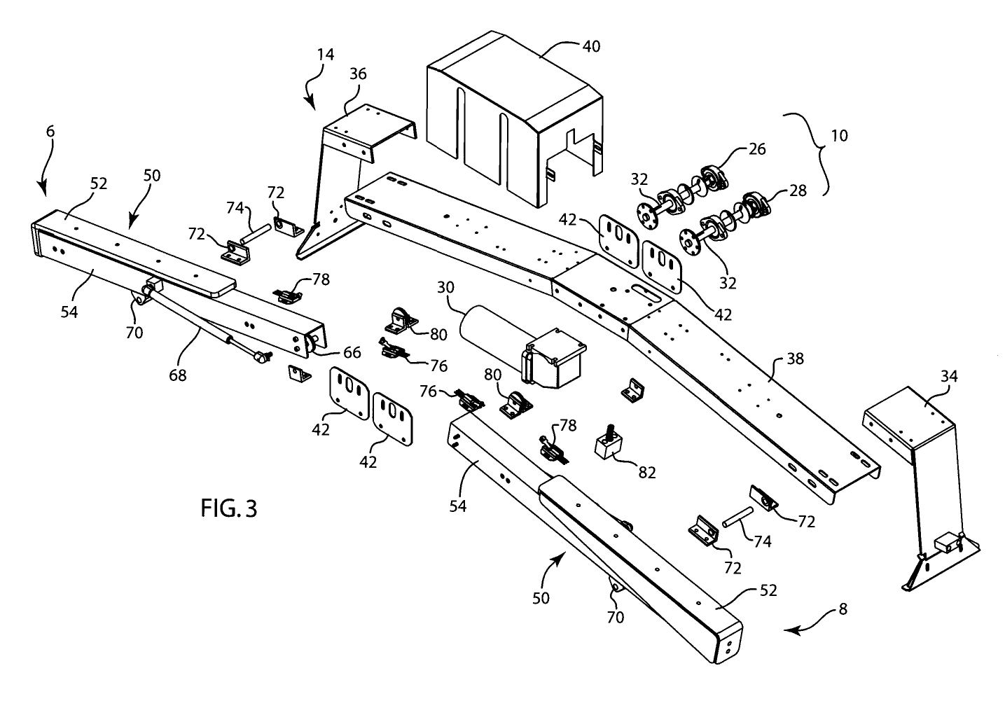

The first and second side assemblies 6, 8 and the drive assembly 10 are interconnected and are attached to the top surface of a vehicle through vehicle top surface mounting assemblies 14 and 16. Referring now to FIG. 3, the first top mounting assembly 14 comprises first and second vehicle top surface mounts 34, 36 adaptable for attachment to the top surface of any vehicle. The vehicle top surface mounts 34, 36 are attached to a main vehicle top surface frame 38. The main vehicle top surface frame 38 has a top surface, side surfaces and a bottom surface. When top surface mounts 34, 36 are attached to main vehicle top surface frame 38, the assembly, in one embodiment, can be mounted to the top surface of a vehicle through tension mounting. The vehicle top surface mounts 34, 36 and vehicle top surface frame 38 includes a series of attachment mechanisms, preferably screws, that allow for adjustment of the tension and proper fitting of the mounting assembly 14 to the top surface of the vehicle 2. Main vehicle top surface frame 38 supports the drive assembly 10 through drive shaft mounting brackets 42. Drive shaft mounting brackets 42 are attached to the main vehicle top surface frame 38 and also support the terminal ends of drive shafts 26, 28. A drive system cover 40 may be used to cover the drive shaft 26, 28 at the terminal ends where the drive shafts mount to the surface frame 38 via drive shaft mounting brackets 42.

Vehicle top surface mounting assemblies 14 and 16 also support utility rack side assemblies 6, 8. The utility rack side assemblies 6, 8 include a front end generally located at the front portion of the vehicle, and back end generally located at the back portion of the vehicle. FIG. 3 demonstrates the assembly of either a front end or back end of the utility rack side assembly 6, 8 to a vehicle top surface mounting assembly 14.

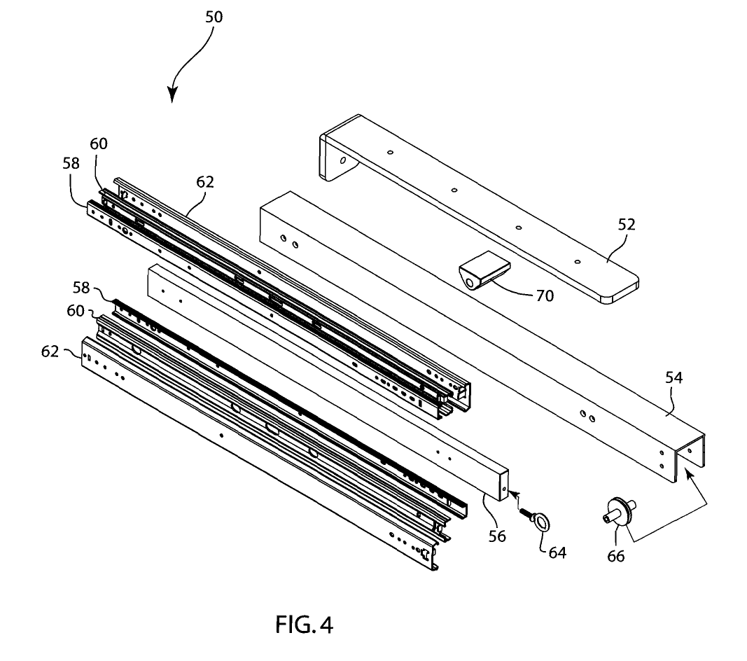

As shown in FIG. 3, the front or back utility rack side assembly comprises an extendible, elongated pivoting member 50. FIG. 4 demonstrates the components of one embodiment of an extendible, elongated pivoting member 50. The extendible, elongated pivoting member 50 includes an extendible bracket unit that slideably extends from or retracts into an additional end of the elongated pivoting member when activated by the drive assembly. The extendible bracket unit is comprised of a pair of inner sliding members 58, a pair of middle sliding members 60, and a pair of outer sliding members 62 with an extendable bracket retention member 56 located between the pair of inner sliding members 58. Inner sliding members 58 may be fixedly attached to extendible bracket retention member 56. Members 58, 60, 62 and 56 are located within elongated pivoting member outer housing 54. In one embodiment, outer sliding members 62 are attached to the inner surface of elongated pivoting member outer housing 54. Middle sliding members 60 engage inner sliding members 58 and outer sliding members 62 to allow extendible bracket retention member 56 to have relative movement vis-à-vis elongated pivoting outer housing member 54, The extendible bracket retention member 56 also has a mounting surface bracket 52 attached thereto such that when the extendible bracket retention member 56 extends from a distal end of elongated pivoting member outer housing 54, mounting surface bracket 52 extends along as well. The proximal end of the extendible bracket retention member 56 includes a cable guide 64 for attachment of cable 100. The proximal end of the elongated pivoting member outer housing 54 further comprises a cable pulley 66 for guiding cable 100 to cable guide 64. The bottom surface of elongated pivoting member outer housing 54 includes a pivot base 70 fixedly attached thereto. The length of the extendible, elongated pivoting member assembly 50 can be varied and is preferably dependent on the height of the vehicle that the utility rack system assembly 4 is mounted on.

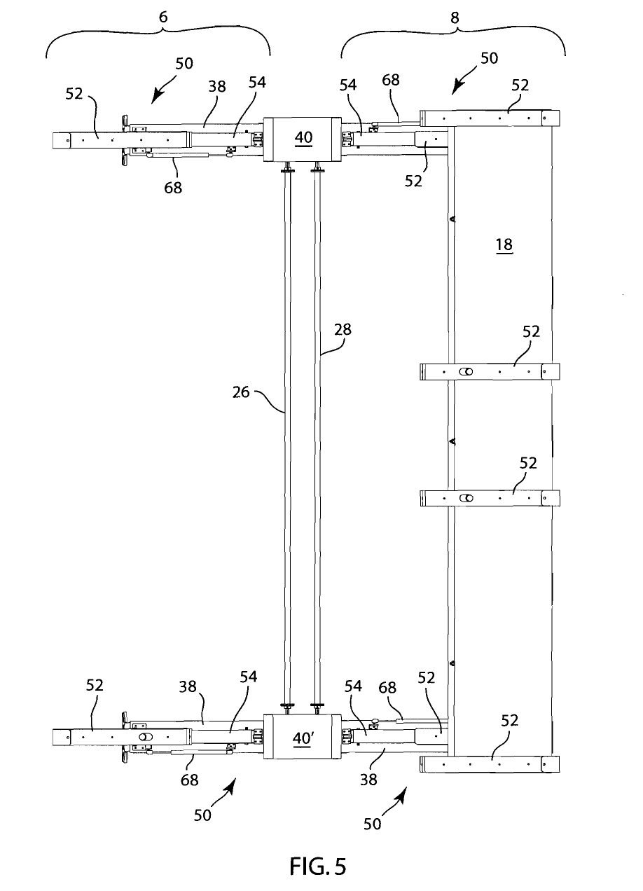

Referring now to FIGS. 3 and 5, extendible, elongated pivoting member 50 is attached to the top surface of the main vehicle top surface frame 38. In one embodiment, outer pivot brackets 72 are fixedly attached to the top surface of frame 38. In that embodiment a pivot rod 74 extends through an opening in pivot base 70 and outer pivot bracket 72 are attached to the terminal ends of pivot rod 74 to allow for the extendible, elongated pivoting member 50 to pivot about the pivot point defined by pivot base 70, outer pivot bracket 72 and pivot rod 74. A biasing member 68 may be coupled to the extendible, elongated pivoting member 50 and the main vehicle top surface frame 38 to bias the elongated pivoting member to the second, extended position. The biasing member in one embodiment comprises at least one pneumatic strut. An acceptable pneumatic strut is available from McMaster Carr of Elmhurst, Ill.

Referring to FIGS. 1-3 and 5, drive assembly 10 operates to move the front end and back end of the utility rack side assembly substantially in unison from a first position generally parallel to the top surface of the vehicle to a second, extended position generally perpendicular to the top surface of the vehicle. In this manner, a person standing at ground level can move an object from an accessible position at ground level to a storage position located at the top surface of the vehicle.

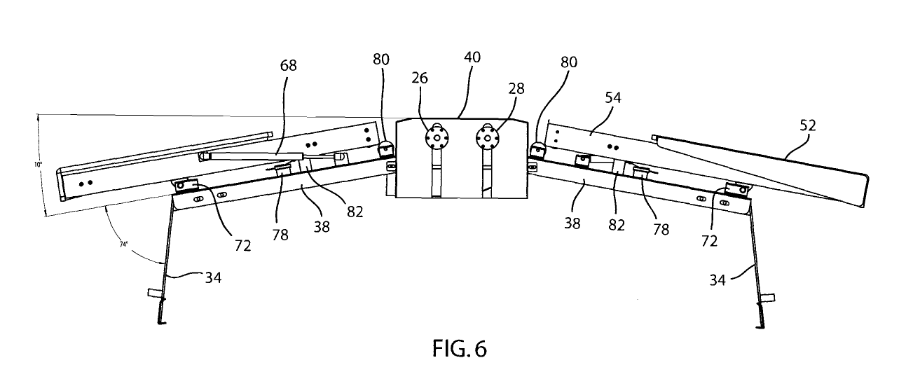

Referring now to FIG. 6, FIG. 6 demonstrates an exemplary scope of pivoting of the side assemblies. As demonstrated in FIG. 6, when the utility rack side assembly is in the storage position at the top surface of the vehicle, the side assemblies may be tilted at a 10° downward angle from the top surface of the drive system cover 40. Preferably, the angle of tilt in the storage position is parallel to the angle of the top surface of the vehicle 2. Acceptable ranges of tilting range from 0° to 25°. As further demonstrated in FIG. 6, when the side assemblies move to the extended position, they may tilt a significant amount to the point where they are substantially perpendicular to the top surface of the vehicle. In one exemplary embodiment, this amount of tilt amounts to 74°. However, the amount of tilt can range anywhere from 40-90°.

As aforementioned, at least one motor 30 is associated with drive shafts 26, 28. The motor may be a reversible motor. In one embodiment, the motor is a 12 volt DC drive motor. In another embodiment, the motor is a 12 volt DC drive reversible motor. Suitable motors are available from Leeson Electric, Grafton, Wis. In one embodiment, a single motor drives both drive shafts 26, 28. In another embodiment, a single motor is associated with each respective drive shaft, 26, 28. Thus, a first motor 30 is associated with drive shaft 26, and a second motor 30′ is associated with drive shaft 28. In this embodiment, a first and second motor may be located at the front end of the vehicle near a front drive system cover 40. Alternatively, the first motor could be located at the front of the vehicle near a first drive system cover 40, while the second motor may be located at the rear of the vehicle near drive system cover 40′, as shown in FIG. 2.

As shown in FIG. 3, each drive shaft 26, 28 includes a front and back cable spooling mechanism 32. Each cable spooling mechanism 32 has a cable 100 coupled thereto. The cable 100 is further coupled to an extendible, elongated pivoting member 50. In one embodiment, e.g., FIG. 2, the cable 100 is coupled at a first end to cable spooling mechanism 32. The cable 100 runs through a cable pulley unit 80 affixed to the top surface of the main vehicle top surface frame 38 near the drive system cover 40. The cable 100 then runs though a cable pulley 66 located in the proximate end of elongated pivoting member outer housing 54, through housing 54, and couples to cable guide 64 of extendible bracket retention member 56.

As shown in FIGS. 1 and 5, when cable 100 is fully retracted onto cable spool mechanism 32, the extendible, elongated pivoting members 50 are located in a position generally parallel with the top surface of the vehicle. As shown in FIG. 3, shock absorbers 82, located on the top surface of the frame 38, engage a bottom surface of the extendible, elongated pivoting member 50 in this storage position. When control unit 12 is activated to lower a side assembly 6 or 8, a motor 30 runs to extend cable 100 from cable spooling mechanisms 32 by driving the rotation of a drive shaft 26 or 28. Since each drive shaft 26, 28 has a front and back cable spooling mechanism, cable 100 will be released from the front and back mechanisms 32 in unison, causing the front and back ends of the utility rack side assembly 6, 8 to lower in unison. Specifically, as cable 100 is extended, the extendible, elongated pivoting members 50 pivot downwardly. As the cable is further extended, the extendible bracket portion of the extendible, elongated pivoting members 50 extends downwardly along the side of the vehicle. When a lower limit switch 76 is activated, the motor stop extending cable 100 and the side assembly is located in its extended position along the side of the vehicle 2 such that it is accessible to a person standing at ground level to load an object thereon.

From the extended position, the user can activate the motor 30 through a control unit 12 such that the motor 30 causes the drive shaft 26 or 28 to retract cable 100. When this occurs, extendible bracket portions of the extendible, elongated pivoting member 50 are retracted into the elongated pivoting member outer housing 54 and the elongated pivoting member 50 pivots back onto the top surface of the main vehicle top surface frame 38. When the extendible, elongated pivoting member 50 engages an upper limit switch located on the main vehicle top surface frame 38, the motor stops running and the cable 100 is fully retracted and the unit is in the storage position. As the extendible, elongated pivoting member 50 retracts onto the main vehicle top surface frame 38, shock absorbers 82 operate to cushion the engagement of member 50 as it retracts back into the storage position.

It is noted that the mounting surface bracket 52 of the elongated pivoting member 50 includes a surface for receiving an object. That object can be a ladder hold down assembly 20, a tool box 18, or any other assembly desired by the customer. In one embodiment, the first utility side rack assembly 6 has a tool box 18 mounted thereon, while the second utility rack side assembly 8 has a ladder receiving assembly thereon. The top surface of the tool box 18 may further include an outer surface for receiving an additional object. The tool box 18 may be designed such that the outer surface is capable of receiving a ladder.

Accordingly, a utility rack 4 for mounting on the top surface of a vehicle 2 is disclosed, the utility rack 4 comprising first and second utility rack side assembly for receiving an object such as a tool box, ladder or the like. The first and second utility rack side assemblies 6, 8 each comprise a front end and back end, the front end and back ends each comprising an extendible, elongated pivoting member 50. Each elongated pivoting member 50 includes an extendible bracket unit that slideably extends from and retracts into a distal end of the elongated pivoting member 50 when activated through a control unit and drive assembly 10. In one embodiment, the lower end of the extendible bracket unit 50 has a surface for receiving an object.

The drive assembly 10 is connected to the utility rack side assemblies 6, 8. The drive assembly 10 comprises at least one motor and a first and second drive shaft 26, 28, the first drive shaft connecting the front and back ends of the first utility rack side assembly. The second drive shaft, likewise, connects the front and back ends of the second drive shaft assembly. Each drive shaft includes a front and back cable spooling mechanism 32. Each cable spooling mechanism 32 has a cable 100 coupled thereto. Each cable 100 is further coupled to an extendible, elongated pivoting member 50 to extend or retract the extendible bracket unit, such that when a drive shaft 26, 28 is activated, the front and back end of a utility rack side assembly 6 or 8, moves substantially in unison. The control unit is functionally connected to the drive assembly for activating the drive assembly in a manner that is well known in the art. The drive assembly operates to selectively move the first or second utility side rack assembly from a first position generally parallel to the top surface of the vehicle to a second, extended position generally perpendicular to the top surface of the vehicle. As noted, front and back vehicle top surface mounting assemblies for supporting the utility rack side assembly at the front and back ends facilitates attachment of the utility rack system assembly 4 to the vehicle 2. The mounting assemblies 14, 16 also support the drive assembly 10.

Accordingly, the present disclosure provides a written description of a utility rack system assembly which fully enables the construction of such assembly to one of ordinary skill in the art. It is apparent to those skilled in the art that the present invention as described herein contains several features, and that variation to the preferred embodiments as disclosed herein may be made which embody only some of the features disclosed herein. In the foregoing description, certain terms have been used for brevity, clearness and understanding. No unnecessary limitations are to be implied therefrom beyond the requirement of the prior art because such terms are used for descriptive purposes and are intended to be broadly construed. The different configuration of systems described herein may be used alone or in combination with other configurations or systems. Various other combinations and modification or alternatives may also be apparent to those skilled in the art. Such various alternatives and other embodiments are contemplated as being within the scope of the following claims that particularly point out and distinctly claim the subject matter regarding the present invention.

What is claimed is:

1. A utility rack for mounting onto a top surface of a vehicle, the utility rack comprising:
At least one utility rack side assembly for receiving an object, the utility rack side assembly comprising a front end and back end, the front end and back ends each comprising an extendible, elongated pivoting member;
a drive assembly connected to the utility side rack assembly, the drive assembly comprising a motor and at least one drive shaft, the drive shaft connecting the front and back ends of the utility rack side assembly;
a control unit functionally connected to the drive assembly for activating the drive assembly;
front and back vehicle top surface mounting assemblies for supporting the utility rack side assembly at the front end and back end and also supporting the drive assembly;
wherein each elongated pivoting member further comprises an extendible bracket unit that slideably extends from and retracts into a distal end of the elongated pivoting member when activated by the drive assembly, the lower end of the extendible bracket unit having a surface for receiving an object;
wherein the drive assembly operates to move the front end and back end of the utility rack side assembly substantially in unison from a first position generally parallel with the top surface of the vehicle to a second, extended position generally perpendicular to the top surface of the vehicle to move an object located in a storage position at the top surface of the to an accessible position to a person standing at ground level.

2. The utility rack of claim 1 wherein the drive shaft of the drive assembly comprises a plurality of cable-spooling mechanisms, each cable spooling mechanism having a cable coupled thereto and wherein each cable is further coupled to one of the front or back extendible, elongated pivoting members to provide movement between the first and second positions.

3. The utility rack of claim 1, wherein drive assembly further comprises at least one biasing member to bias the elongated pivoting member to the second, extended position.

4. The utility rack of claim 3 wherein the biasing member comprises at least one pneumatic strut and wherein the drive shaft of the drive assembly comprises a plurality of cable-spooling mechanisms, each cable spooling mechanism having a cable coupled thereto and wherein each cable is further coupled to one of the front or back extendible, elongated pivoting members to provide movement between the first and second positions.

5. The utility rack of claim 1, wherein the motor is a reversible motor and the motor drives the extension or retraction of cable from the cable spooling mechanisms, such that when the cable is extended, the elongated pivoting members move to the second, extended position, and when cable is retracted the elongated pivoting members move to the first position.

6. The utility rack of claim 1, wherein surface for receiving an object further comprises a surface for receiving a ladder.

7. The utility rack of claim 1, wherein surface for receiving an object further comprises an elongated toolbox, the toolbox extending from the front end to the back end of the side assembly.

8. The utility rack of claim 7, wherein toolbox includes a an outer surface for receiving an additional object.

9. The utility rack of claim 8, wherein the additional object is a ladder.

10. The utility rack of claim 1, wherein the control unit is located inside of the vehicle.

11. A utility rack for mounting onto a top surface of a vehicle, the utility rack comprising:
A first and second utility rack side assembly for receiving an object, the first and second utility rack side assembly each comprising a front end and back end, the front end and back ends each comprising an extendible, elongated pivoting member, each elongated pivoting member further comprising an extendible bracket unit that slideably extends from and retracts into a distal end of the elongated pivoting member when activated, the lower end of the extendible bracket unit having a surface for receiving an object;
a drive assembly connected to the utility side rack assemblies, the drive assembly comprising at least one motor and at a first and second drive shaft, the first drive shaft connecting the front and back ends of the first utility rack side assembly, and the second drive shaft connecting the front and back ends of the second drive shaft assembly, each drive shaft comprising a front and back cable-spooling mechanism, each cable spooling mechanism having a cable coupled thereto and wherein each cable is further coupled to an extendible, elongated pivoting member to extend or retract the extendible bracket unit, such that when a drive shaft is activated, the front and back ends of a utility rack side assembly move substantially in unison;
a control unit functionally connected to the drive assembly for activating the drive assembly;
wherein the drive assembly operates to selectively move the first or second utility rack side assemblies from a first position generally parallel with the top surface of the vehicle to a second, extended position generally perpendicular to the top surface of the vehicle.

12. The utility track of claim 11, further comprising front and back vehicle top surface mounting assemblies for supporting the utility rack side assembly at the front end and back end and also supporting the drive assembly.

13. The utility rack of claim 11, wherein drive assembly further comprises at least one biasing member to bias the elongated pivoting member to the second, extended position.

14. The utility rack of claim 13 wherein the biasing member comprises at least one pneumatic strut.

15. The utility rack of claim 11, wherein the motor is a reversible motor and the motor drives the extension or retraction of cable from the cable spooling mechanisms, such that when the cable is extended, the elongated pivoting members move to the second, extended position, and when cable is retracted the elongated pivoting members move to the first position.

16. The utility rack of claim 11, wherein surface for receiving an object further comprises a surface for receiving a ladder.

17. The utility rack of claim 11 wherein surface for receiving an object further comprises an elongated toolbox, the toolbox extending from the front end to the back end of the side assembly.

18. The utility rack of claim 17, wherein toolbox includes a an outer surface for receiving an additional object.

19. The utility rack of claim 18, wherein the additional object is a ladder.

20. The utility rack of claim 1, wherein the control unit is located inside of the vehicle.
